(19) United States
(12) Patent Application Publication
(10) Pub. No.: US 2005/0057169 A1
(43) Pub. Date: Mar. 17, 2005

(54) Light receiving and emitting electronic apparatus

(75) Inventors: Yoichiro Noguchi, Kyoto (JP); Junji Fujino, Kyoto (JP)

Correspondence Address: MORGAN LEWIS & BOCKIUS LLP, 1111 PENNSYLVANIA AVENUE NW, WASHINGTON, DC, 20004, US

(73) Assignee: ROHM CO., LTD.

(21) Appl. No.: 10/902,434

(22) Filed: Jul. 30, 2004

(30) Foreign Application Priority Data
Jul. 31, 2003 (JP) P2003-284576
Jun. 10, 2004 (JP) P2004-172504

(51) Int. Cl. H05B 37/02

(52) U.S. Cl. 315/150

(57) ABSTRACT

A light receiving and emitting electronic apparatus having a light emitting device, a light receiving device, and a driving device for driving the light emitting device and the light receiving device, and serving to transmit/receive data to/from an outside through the light emitting device and the light receiving device, comprising a data signal input terminal for inputting a data signal from a data signal control device for controlling the driving device in order to transmit/receive data to/from the outside, a remote control signal input terminal for inputting a remote control signal from a remote control signal control device for controlling the driving device in order to remotely operate an external electronic apparatus, first current generating means for driving a suitable current for transmitting and receiving data into the light emitting device, second current generating means for driving a suitable current for transmitting the remote control signal into the light emitting device, and means for selectively switching the first and second current generating means.

### BACKGROUND OF THE INVENTION

1.Field of the Invention

The present invention relates to a light receiving and emitting electronic apparatus comprising so-called light emitting and receiving devices, and includes an electronic apparatus to be used as communicating means, for example. An IrDA module to be incorporated into a mobile phone for carrying out an infrared communication in accordance with a standard made by an IrDA (Infrared Data Association: a standardized group for promoting the mutual connection of a data communication using infrared rays) corresponds to the electronic apparatus according to the invention.

2.Description of the Related Art

Reflecting the recent spread of a mobile terminal and the prevalence of a reduction in a size and an increased multiplex functions, an IrDA module in a mobile phone is not limited to a data exchange function such as the exchange of a telephone number which is a conventional function, but rather, a mobile phone 13, which incorporates an IrDA module 100 with a remote control transmitting function such as the remote control transmitting function for controlling electric household appliances as shown in FIG. 1, has been introduced into the market. This was realized because the wavelength of a light signal emitted from the IrDA module 100, which transmits an IrDA data signal as a kind of data signals, and the wavelength of a light signal of a remote controller used for a remote control operation areal most identical to eachother. Therefore, both functions of data exchange performed by the IrDA module 100 and remote control performed by the remote control circuit can be implemented by using the same light emitting device by changing the drive current of an LED 122 as a light emitting device and regulating the radiant intensity thereof.

As shown in FIG. 1, the mobile phone 13 corresponding to the remote control transmitting function is provided with the IrDA module 100, a data signal control device (an IrDA controller 2) provided on the outside of the IrDA module 100 and serving to control a timing for driving current generating means (an IrDA driver) to drive the LED 122 which is controlled by a CPU 4 of the mobile phone, a first resistor 6 (R1) for regulating the radiant intensity of the LED 122, a remote control signal control device (a remote controller 3) provided on the outside of the IrDA module 100 and serving to control a timing for driving the current generating means (the remote control driver) to drive the LED 122 which is controlled by the CPU 4 of the mobile phone in order to correspond to a remote control transmitting function in addition to an LEDVCC 5 to be the driving voltage of the LED 122, a switch 8 (SW) for selecting a radiant intensity which is suitable for transmitting an IrDA data signal from the IrDA controller 2 or a radiant intensity which is suitable for transmitting a remote control signal sent from the remote controller 3, and a second resistor 7 (R2) therefor, and is thus constituted together with a display portion 12, an antenna 9, a communication CPU 10 for controlling the antenna 9, and a keyboard 11 which are other components.

FIG. 2 is a detailed block diagram in which the IrDA module 100 is incorporated into the mobile phone 13 shown in FIG. 1 (before a remote control transmitting function is added) and FIG. 3 is a detailed block diagram in which the IrDA module 100 is mounted on the mobile phone 13 shown in FIG. 1 (after the remote control transmitting function is added). The IrDA module 100 is constituted by the LED 122 for converting an electric signal sent from the mobile phone 13 into a light signal and transmitting the same light signal, a photodiode 120 for receiving data from an outside through the light signal and converting the same light signal into an electric signal, a driving device 121 for driving the LED 122 and the photodiode 120, a board 123, and terminal groups 125 to 129.

In the mobile phone 13 shown in FIG. 1, a timing for causing the LED 122 to emit a light is controlled depending on the use of the IrDA controller 2 or the remote controller 3 and a radiant intensity is regulated by controlling the drive current of the LED 122 depending on the transmission of a signal sent from the IrDA controller 2 or a signal sent from the remote controller 3, thereby transmitting a desirable light signal. More specifically, in the transmission of a remote control signal using the remote controller 3 requiring a higher radiant intensity than that in the transmission of the IrDA data signal using the IrDA controller 2, the second resistor 7 is not used but only the first resistor 6 is used through the switch 8 attached to the outside of the IrDA module 100, thereby increasing the drive current of the LED 122. As compared with the transmission of the IrDA data signal using the IrDA controller 2, a larger current is driven to the LED 122. Thus, the LED 122 is caused to emit a light with a radiant intensity which is suitable for the transmission of a remote control signal, and the remote control signal is thus transmitted. Moreover, a lower radiant intensity than that in the transmission of the remote control signal using the remote controller 3 is used for the transmission of the IrDA data signal using the IrDA controller 2. By using two resistors, that is, the second resistor 7 and the first resistor 6 through the switch 8 attached to the outside, therefore, a smaller current than that in the transmission of the remote control signal is driven to the LED 122 and the LED 122 is caused to emit a light with a radiant intensity which is suitable for the transmission of the IrDA data signal, and the IrDA data signal is thus transmitted.

### SUMMARY OF THE INVENTION

In consideration of the conventional actual circumstances, the invention has been made to eliminate drawbacks inherent in the conventional art, and therefore, has a first object to provide a light receiving and emitting electronic apparatus mainly comprising an IrDA module having a remote control transmitting function which includes an interface to easily satisfy the specification of an external part to be changed by various products without requiring to dispose, on the outside of the light receiving and emitting electronic apparatus, a change-over switch for regulating the drive current of a light emitting device, and excessive wirings and resistors therefor, and has a second object to provide a mobile terminal using the light receiving and emitting electronic apparatus.

The first object can be attained by a first aspect of the invention which is directed to a light receiving and emitting electronic apparatus having a light emitting device, a light receiving device, and a driving device for driving the light emitting device and the light receiving device, and serving to transmit/receive data to/from an outside through the light emitting device and the light receiving device, comprising a data signal input terminal for inputting a data signal from a data signal control device for controlling the driving device in order to transmit/receive data to/from the outside, a remote control signal input terminal for inputting a remote control signal from a remote control signal control device for controlling the driving device in order to remotely operate an external electronic apparatus, first current generating means for driving a suitable current for transmitting and receiving data into the light emitting device, second current generating means for driving a suitable current for transmitting the remote control signal into the light emitting device, and means for selectively switching the first and second current generating means.

The first object can be attained by a second aspect of the invention which is directed to the light receiving and emitting electronic apparatus according to the first aspect of the invention, wherein both a data signal sent from the data signal control device and a remote control signal sent from the remote control signal control device are input to either of the data signal input terminal and the remote control signal input terminal.

The first object can be attained by a third aspect of the invention which is directed to a driving device comprising first current generating means for driving a suitable current for transmitting data into a light emitting device, second current generating means for driving a suitable current for transmitting a remote control signal into the light emitting device, means for selectively switching the first and second current generating means, a terminal for transmitting a signal to the light emitting device, and a terminal for receiving a signal from a light receiving device.

The first object can be attained by a fourth aspect of the invention which is directed to a light receiving and emitting electronic apparatus comprising a light emitting device connected to a terminal for transmitting a signal to the light emitting device, a light receiving device connected to a terminal for receiving a signal from the light receiving device, and the driving device according to the third aspect of the invention.

The first object can be attained by a fifth aspect of the invention which is directed to the light receiving and emitting electronic apparatus according to the fourth aspect of the invention, further comprising a data signal input terminal for inputting a data signal from a data signal control device for controlling the driving device in order to transmit/receive data to/from an outside, and a remote control signal input terminal for inputting a remote control signal from a remote control signal control device for controlling the driving device in order to remotely operate an external electronic apparatus.

The first object can be attained by a sixth aspect of the invention which is directed to the light receiving and emitting electronic apparatus according to the fourth aspect of the invention, further comprising an input terminal for inputting a signal from a control device serving as a data/remote controller which serves to control the driving device in order to transmit/receive data to/from an outside and to control the driving device in order to remotely operate an external electronic apparatus.

The first object can be attained by a seventh aspect of the invention which is directed to the light receiving and emitting electronic apparatus according to the fourth aspect of the invention, further comprising at least two input terminals,
wherein in the case in which a data signal control device for controlling the driving device in order to transmit/receive data to/from an outside and a remote control signal control device for controlling the driving device in order to remotely operate an external electronic apparatus are provided separately,
a data signal is input from the data signal control device to one of the input terminals of the light receiving and emitting electronic apparatus and a remote control signal is input from the remote control signal control device to the other input terminal of the light receiving and emitting electronic apparatus, and
in the case in which a control device serving as a data/remote controller for controlling the driving device in order to transmit/receive data to/from the outside and controlling the driving device in order to remotely operate the external electronic apparatus is used,
it can be used even if a signal is input from the control device serving as a data/remote controller to either of the two input terminals of the light receiving and emitting electronic apparatus.

The first object can be attained by an eighth aspect of the invention which is directed to the light receiving and emitting electronic apparatus according to the fourth aspect of the invention, further comprising at least two input terminals,
wherein in the case in which a data signal control device for controlling the driving device in order to transmit/receive data to/from an outside and a remote control signal control device for controlling the driving device in order to remotely operate an external electronic apparatus are provided separately,
a data signal is input from the data signal control device to one of the input terminals of the light receiving and emitting electronic apparatus and a remote control signal is input from the remote control signal control device to the other input terminal of the light receiving and emitting electronic apparatus, and
in the case in which a control device serving as a data/remote controller for controlling the driving device in order to transmit/receive data to/from the outside and controlling the driving device in order to remotely operate the external electronic apparatus is used,
a signal is input from the control device serving as a data/remote controller to the input terminal to which the remote control signal is input when the data signal control device and the remote control signal control device are provided separately.

The first object can be attained by a ninth aspect of the invention which is directed to the light receiving and emitting electronic apparatus according to the fourth aspect of the invention, further comprising at least two input terminals,
wherein in the case in which a data signal control device for controlling the driving device in order to transmit/receive data to/from an outside and a remote control signal control device for controlling the driving device in order to remotely operate an external electronic apparatus are provided separately,
a data signal is input from the data signal control device to one of the input terminals of the light receiving and emitting electronic apparatus and a remote control signal is input from the remote control signal control device to the other input terminal of the light receiving and emitting electronic apparatus, and

in the case in which a control device serving as a data/remote controller for controlling the driving device in order to transmit/receive data to/from the outside and controlling the driving device in order to remotely operate the external electronic apparatus is used,
a signal is input from the control device serving as a data/remote controller to the input terminal to which the data signal is input when the data signal control device and the remote control signal control device are provided separately.

The first object can be attained by a tenth aspect of the invention which is directed to the light receiving and emitting electronic apparatus according to any of the first, second and fourth to ninth aspects of the invention, wherein the light emitting device is an LED and the light receiving device is a photodiode.

The first object can be attained by an eleventh aspect of the invention which is directed to the light receiving and emitting electronic apparatus according to any of the first, second and fourth to tenth aspects of the invention, wherein the data signal control device is an IrDA controller.

The second object can be attained by a twelfth aspect of the invention which is directed to a mobile terminal mounting the light receiving and emitting electronic apparatus according to any of the first, second and fourth to eleventh aspects of the invention.

When designing a mobile phone incorporating an IrDA module according to an example of a light receiving and emitting electronic apparatus, it is possible to carry out the design without providing, on the outside of the IrDA module, a switch for regulating the radiant intensity of an LED to be mounted on the IrDA module, and excessive wirings and resistors. In the mobile phone desired to reduce a size, in many cases, an IrDA module having a remote control transmitting function according to an example of the light receiving and emitting electronic apparatus in accordance with the invention is particularly mounted on the tip portion of a mobile terminal to depend on the size of the circuit board of the mobile terminal. In such cases, it is possible to reduce the size of the circuit board of the mobile terminal which is linked to a reduction in a size. When designing the mobile terminal, moreover, the IrDA module having a remote control transmitting function according to an example of the light receiving and emitting electronic apparatus in accordance with the invention is used for a sudden change in a wiring or a change in the number of controllers to be mounted. Consequently, disadvantages can be caused by the change with difficulty. More specifically, it is possible to provide an interface for easily satisfying the specification of the outside of the light receiving and emitting electronic apparatus which is changed depending on a product.

### BRIEF DESCRIPTION OF THE DRAWINGS

FIG. 1 is a schematic diagram showing a mobile phone having a remote control transmitting function mounting a conventional IrDA module and a remote controller for adding the remote control transmitting function thereto, in which the transmission of a remote control signal and an IrDA data signal is carried out by using the mobile phone,

FIG. 2 is a block diagram showing the connection of the conventional IrDA module, an IrDA controller and an LEDVCC (before the remote control transmitting function is added),

FIG. 3 is a block diagram showing the connection of the conventional IrDA module, the IrDA controller, the remote controller and the LEDVCC (after the remote control transmitting function is added),

FIG. 4 is a perspective view showing the appearance of an IrDA module having a remote control transmitting function according to an example of a light receiving and emitting electronic apparatus,

FIG. 5 is a block diagram showing the connection of the IrDA module having a remote control transmitting function according to the example of the light receiving and emitting electronic apparatus in accordance with the invention, the IrDA controller, the remote controller and the LEDVCC (the IrDA controller and the remote controller are provided separately),

FIG. 6 is a block diagram showing the connection of the IrDA module having a remote control transmitting function according to the example of the light receiving and emitting electronic apparatus in accordance with the invention, a controller serving as an IrDA remote/controller and the LEDVCC (the IrDA controller and the remote controller are used together), and

FIG. 7 is a block diagram showing the IrDA module having a remote control transmitting function according to the example of the light receiving and emitting electronic apparatus in accordance with the invention which mainly includes a driving device.

### DESCRIPTION OF THE PREFERRED EMBODIMENTS

The best mode for carrying out the invention will be described below.

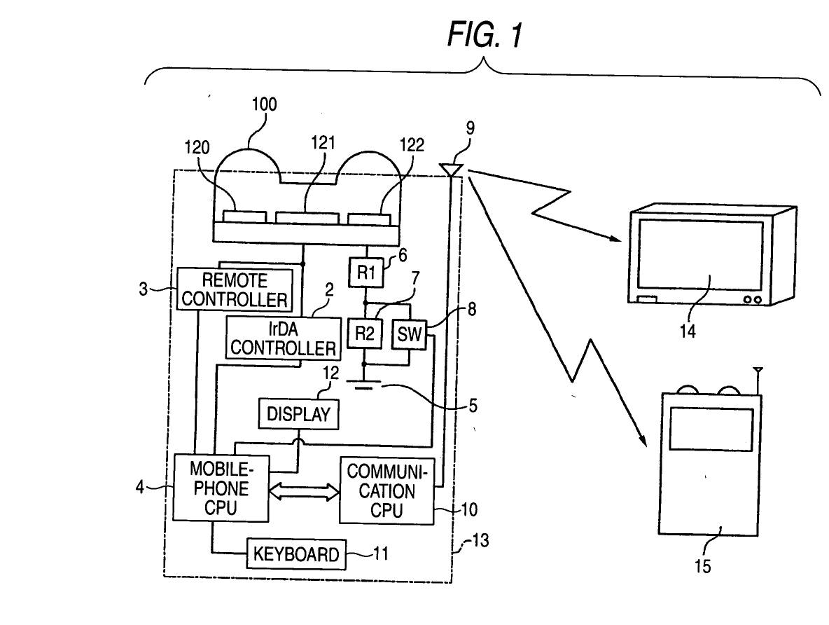

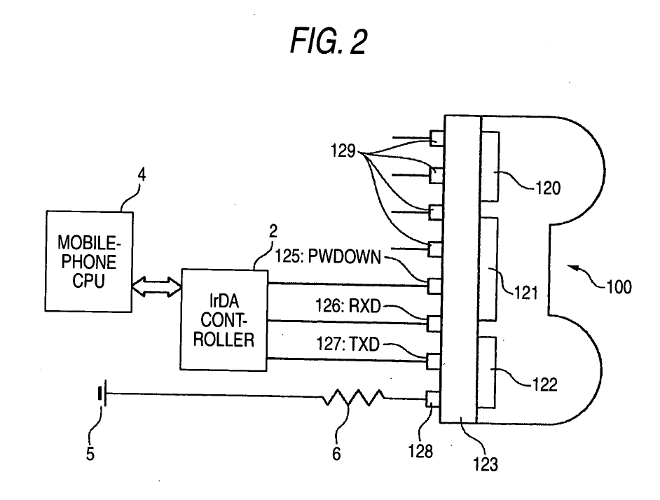

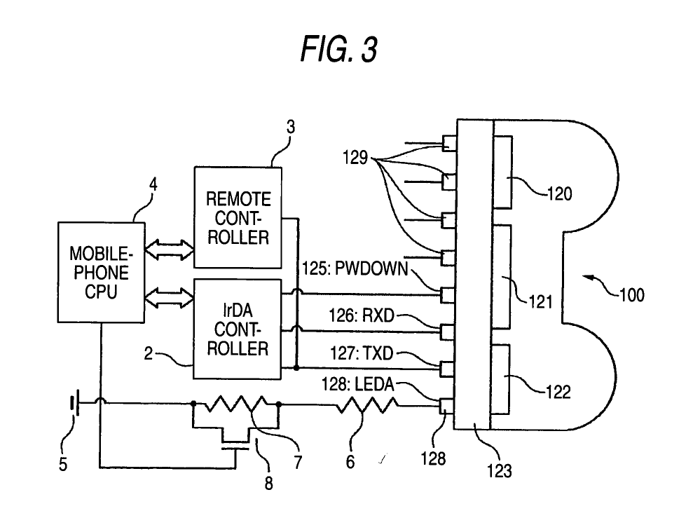

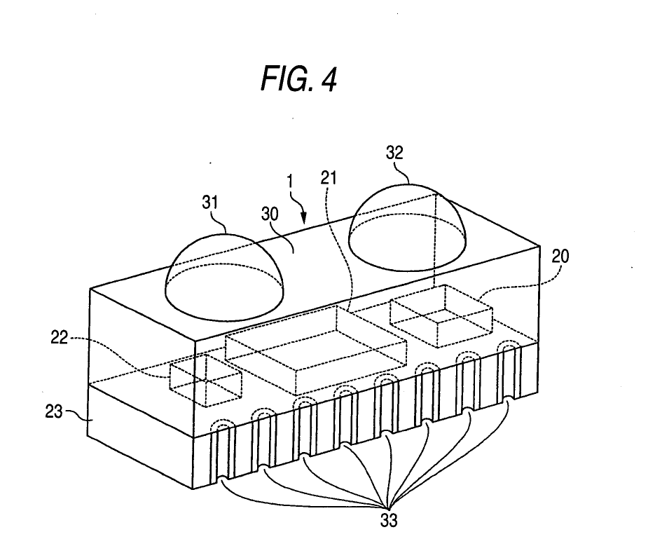

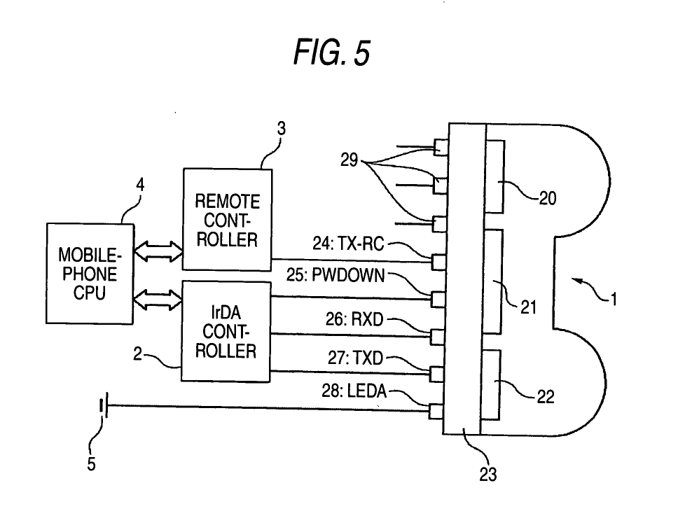

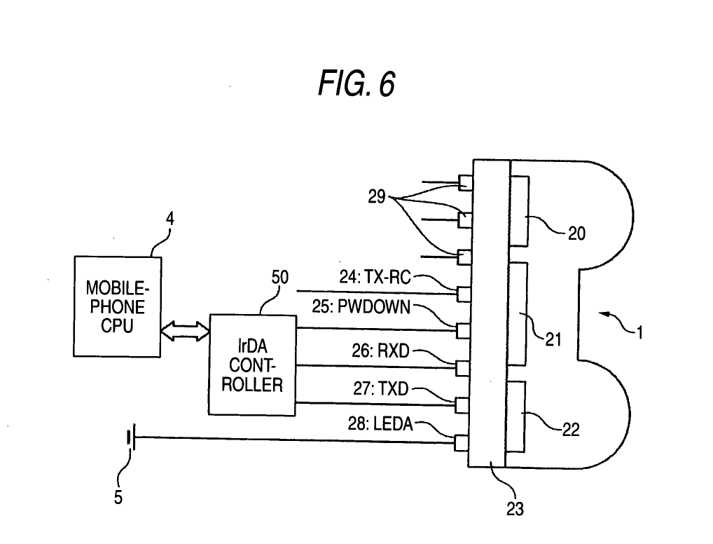

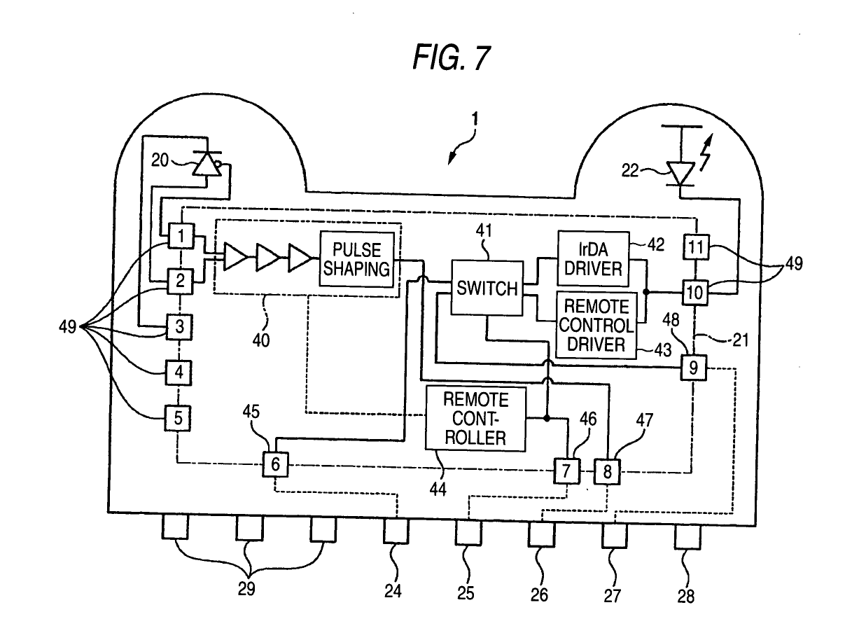

FIG. 1 is a schematic diagram showing a mobile phone having a remote control transmitting function mounting a conventional IrDA module and a remote controller for adding the remote control transmitting function thereto, in which the transmission of a remote control signal and an IrDA data signal is carried out by using the mobile phone, FIG. 2 is a block diagram showing the connection of the conventional IrDA module, an IrDA controller and an LEDVCC (before the remote control transmitting function is added), FIG. 3 is a block diagram showing the connection of the conventional IrDA module, the IrDA controller, the remote controller and the LEDVCC (after the remote control transmitting function is added), FIG. 4 is a perspective view showing the appearance of an IrDA module having a remote control transmitting function according to an example of a light receiving and emitting electronic apparatus in accordance with the invention, FIG. 5 is a block diagram showing the connection of the IrDA module having a remote control transmitting function according to the example of the light receiving and emitting electronic apparatus in accordance with the invention, the IrDA controller, the remote controller and the LEDVCC (the IrDA controller and the remote controller are provided separately), FIG. 6 is a block diagram showing the connection of the IrDA module having a remote control transmitting function according to the example of the light receiving and emitting electronic apparatus in accordance with the invention, a controller serving as an IrDA/remote controller and the LEDVCC (the IrDA controller and the remote controller a reused together), and FIG. 7 is a block diagram showing the IrDA module having a remote control transmitting function according to the invention which mainly includes a driving device.

The light receiving and emitting electronic apparatus according to the invention is generally constituted by a board 23 formed to take a long rectangular shape seen on a plane, a light emitting device, a light receiving device and a driving device 21 which are mounted on the board 23, and a sealing member 30 formed by a resin package for integrally sealing them. Examples of the light receiving and emitting electronic apparatus include an IrDA module 1 having a remote control transmitting function in which an LED 22 is set to be the light emitting device and a photodiode 20 is set to be the light receiving device. The board 23 is formed by a glass epoxy resin and a predetermined wiring pattern of a conductor (not shown) is formed on a surface thereof. A plurality of connecting terminal portions 33 provided with a conductor layer on the internal surface of a concave groove extended in the direction of the thickness of the board 23 is formed on the side surface of the board 23. The connecting terminal portions 33 are connected to the wiring pattern formed on the surface of the board 23. Moreover, a light emitting lens 31 is formed on the surface opposed to the LED 22 and a light receiving lens 32 is formed on the surface opposed to the photodiode 20.

The LED 22 is mounted on the board 23, and is subjected to wire bonding through a gold wire and is connected to a wiring pattern. In the same manner as the LED 22, the photodiode 20 is mounted on the board 23, and is subjected to the wire bonding through the gold wire and is connected to the wiring pattern. Moreover, the driving device 21 serves to control the transmitting and receiving operations of the LED 22 and the photodiode 20, and is mounted on the board 23, is subjected to the wire bonding through the gold wire and is connected to the wiring pattern, and furthermore, is connected to the LED 22 and the photodiode 20 through the wiring pattern.

As a matter of course, the number of the terminals of the connecting terminal portion 33 is not restricted to eight as shown in FIG. 4. Moreover, a shield case for suppressing the influence of an ambient electromagnetic wave may be provided to cover the external shape of the IrDA module 1 having a remote control transmitting function, which is not shown.

Next, description will be given to a method of mounting the IrDA module 1 having a remote control transmitting function according to an example of the light receiving and emitting electronic apparatus shown in FIG. 4 on a circuit board (an external circuit board) of a mobile terminal. A wiring pattern of a conductor corresponding to each connecting terminal 33 of the IrDA module 1 having a remote control transmitting function is formed on the surface of the external circuit board. When mounting the IrDA module 1 having a remote control transmitting function on the external circuit board, the back face of the board 23 is mounted in an orthogonal direction to the surface of the external circuit board and the connecting terminal portion 33 and a wiring pattern formed on the surface of the external circuit board are bonded to each other through soldering. In this case, an opening portion to be the board terminal connecting portion 33 is constituted to be mounted on the wiring pattern of the conductor. In the IrDA module 1 having a remote-control transmitting function, the back face of the board 23 may be mounted to abut on the external circuit board.

The IrDA module 1 having a remote control transmitting function which is connected to the external circuit board through the soldering and a controller for giving a control signal to the IrDA module 1 having a remote control transmitting function to transmit a desirable signal are connected to each other through the wiring pattern of the conductor on the surface of the external circuit board. There are the case in which an IrDA controller 2 and a remote controller 3 are provided as separate controllers on the external circuit board as shown in FIG. 5 and the case in which a controller 50 using the IrDA controller and are mote controller together (a controller serving as an IrDA/remote controller) is provided on the external circuit board as shown in FIG. 6.

Next, description will be given to the operations of the driving device and the IrDA module which are divided into the case in which the IrDA controller 2 and the remote controller 3 are used separately (FIG. 5) and the case in which the controller 50 serving as the IrDA/remote controller is used (FIG. 6).

In the case in which the IrDA controller 2 and the remote controller 3 are used separately (FIG. 5), a pad 6 (45), a pad 7 (46) and a pad 9 (48) of the driving device 21 shown in FIG. 7 are connected to three input terminals, that is, a TX-RC terminal 24 to be a remote control signal input terminal, a PWDOWN terminal 25 and a TXD terminal 27 to be a data signal input terminal through wire bonding or a wiring pattern, respectively. Therefore, the IrDA module 1 having a remote control transmitting function carries out five operations of “a” to “e” shown in Table 1 depending on a signal state into the three input terminals.

TABLE 1

| | INPUT | | | Status | |
|---|---|---|---|---|---|
| | PWDOWN | TX-RC | TXD | LED Mode | Receiver |
| a | L | L | L | OFF | ON |
| b | L | L | H | IrDA | ON |
| c | L | H | L | Remote | ON |
| b | L | H | H | IrDA | ON |
| d | H | L | L | OFF | OFF |
| e | H | L | H | Remote | OFF |
| e | H | H | L | Remote | OFF |
| e | H | H | H | Remote | OFF |

More specifically, a) in the case in which the PWDOWN terminal 25, the TX-RC terminal 24 and the TXD terminal 27 are low level states (L), a switch 41 is brought into such a state as to transmit a signal to neither an IrDA driver 42 to be current generating means for regulating a current to flow to the LED 22 in order to implement the radiant intensity of the LED 22 which is suitable for sending the IrDA data signal from the IrDA controller 2 nor a remote control driver 43 to be current generating means for regulating a current to flow to the LED 22 in order to implement the radiant intensity of the LED 22 which is suitable for sending a remote control signal from the remote controller 3, and the LED 22 is not driven. b) In the case in which the PWDOWN terminal 25 has L, the TX-RC terminal 24 has L and the TXD terminal 27 has a high level (H) or the PWDOWN terminal 25 has L, the TX-RC terminal 24 has H and the TXD terminal 27 has H, the switch 41 is brought into such a state as to transmit a signal to the IrDA driver 42 and the LED 22 is driven in an IrDA data signal transmitting mode. c) In the case in which the PWDOWN terminal 25 has L, the TX-RC terminal 24 has H and the TXD terminal 27 has L, the switch 41 is brought into such a state as to transmit a signal to the remote control driver 43 and the LED 22 is driven in a remote control signal transmitting mode. d) In the case in which the PWDOWN terminal 25 has H, the TX-RC terminal 24 has L and the TXD terminal 27 has L, the switch 41 is brought into such a state as to transmit a signal to neither the IrDA driver 42 nor the remote control driver 43, and the LED 22 is not driven. e) In the case in which the PWDOWN terminal 25 has H, the TX-RC terminal 24 has L and the TXD terminal 27 has H, the PWDOWN terminal 25 has H, the TX-RC terminal 24 has H and the TXD terminal 27 has L, or the PWDOWN terminal 25 has H, the TX-RC terminal 24 has H, and the TXD terminal 27 has H, that is, the PWDOWN terminal 25 has H, and the TX-RC terminal 24 or the TXD terminal 27 has H, the switch 41 is brought into such a state as to transmit a signal to the remote control diver 43 and the LED 22 is driven in the remote control signal transmitting mode.

In the “a” to “e”, in the case in which the PWDOWN terminal 25 has L, a power down controller 44 for causing a portion (a received signal processing portion 40) including a low-pass filter, a comparator and pulse shaping through which a received signal passes to be non-conductive is not driven but the received signal processing portion 40 is brought into a conductive state so that a receiving circuit is turned ON. In the case in which the PWDOWN terminal 25 has H, the power down controller 44 for causing the received signal processing portion 40 to be non-conductive is driven and the received signal processing portion 40 is brought into the non-conductive state so that the receiving circuit is turned OFF.

A pad 47 of the driving device 21 shown in FIG. 7 is connected to an RXD terminal 26 and another pad portion 49 is connected to a ground or a power source, and an LEDA terminal 28 shown in FIG. 5 is connected to an LEDVCC 5 and another terminal 29 is connected to the ground or the power source. Apad portion 10 indicated by another pad portion 49 in FIG. 7 is a terminal for transmitting a signal from the driving device 21 to the LED 22 to be the light emitting device, and pad portions 1 and 2 indicated by the pad portion 49 are terminals for causing the driving device 21 to receive a signal from the photodiode 20 to be the light receiving device.

When the IrDA controller 2 and the remote controller 3 are provided separately (FIG. 5), the states indicated as “a” to “e” of the IrDA module 1 having a remote control transmitting function in the Table 1 are combined to carry out a data communication by mobile phones mounting the IrDA module 1 having a remote control transmitting function or the remote control of electric household appliances using the mobile phone mounting the IrDA module 1 having a remote control transmitting function.

For example, when data such as a telephone number are to be transmitted or received by using the IrDA module 1 having a remote control transmitting function between mobile phones, the mobile phone on a data transmitting side is brought into the state of “b” in the Table 1 through a CPU 4 of the mobile phone which is mounted on the mobile phone and a data transmission is then started. More specifically, the IrDA controller 2 is selected on the transmitting side, and the switch 41 in FIG. 7 is brought into such a state as to transmit a signal to the IrDA driver 42 and a signal sent from the IrDA controller 2 in FIG. 5 is input from the TXD terminal 27 to drive the IrDA driver 42 in FIG. 7, and the driven IrDA driver 42 drives the LED 22, thereby transmitting the IrDA data signal with aradiant intensitycorrespondingtotheIrDAsignal transmitting function.

On a receiving side, the mobile phone is set in the state of“a” in the Table 1, and the receiving circuit is ON. Therefore, the IrDA data signal is received from the transmitting side through the photodiode 20 shown in FIG. 7 and the IrDA data signal is caused to pass through the received signal processing portion 40. Consequently, a noise included in the received IrDA data signal is removed to carry out waveform shaping, and the same signal is then transmitted to the CPU 4 of the mobile phone through the IrDA controller 2 in FIG. 5 via a pad 8 of the driving device 21 and the RXD terminal 26 of the IrDA module 1 having a remote control transmitting function which is connected to the pad 8 of the driving device 21.

When the electric household appliances are to be controlled remotely by using.the IrDA module 1 having a remote control transmitting function, moreover, the remote controller 3 in FIG. 7 is selected by the CPU 4 of the mobile phone which is mounted on the mobile phone in FIG. 5, the switch 41 is brought into such a state as to transmit a signal to the remote control driver 43, a signal sent from the remote controller 3 in FIG. 5 is input from the TX-RC terminal 24 to drive the remote control driver 43 in FIG. 7, and the driven remote control driver 43 drives the LED 22, thereby transmitting a remote control signal with a radiant intensity corresponding to the remote control transmitting function.

In the case in which the controller 50 serving as an IrDA/remote controller in which the IrDA controller 2 and the remote controller 3 are used together is utilized (FIG. 6), the pad 7(46) and the pad 9(48) in the driving device 21 shown in FIG. 7 are connected to two input terminals, that is, the PWDOWN terminal 25 and the TXD terminal 27 to be the data signal input terminal through wire bonding or a wiring pattern respectively. Therefore, the IrDA module 1 having a remote control transmitting function carries out four operations of “f” to “i” shown in Table 2 depending on a signal state into the two input terminals.

TABLE 2

| | |
|---|---|
| INPUT | Status |

| | PWDOWN | TXD | LED Mode | Receiver |
|---|---|---|---|---|
| f | L | L | OFF | ON |
| g | L | H | IrDA | ON |
| h | H | L | OFF | OFF |
| i | H | H | Remote | OFF |

More specifically, f). in the case in which the PWDOWN terminal 25 has L and the TXD terminal has L, the switch 41 is brought into such a state as to transmit a signal to neither the IrDA driver 42 nor the remote control driver 43, and the LED 22 is not driven. g) In the case in which the PWDOWN terminal 25 has L and the TXD terminal 27 has H, the switch 41 is brought into such a state as to transmit a signal to the IrDA driver 42 and the LED 22 is driven in the IrDA data signal transmitting mode. h) In the case in which the PWDOWN terminal 25 has H and the TXD terminal 27 has L, the switch 41 is brought into such a state as to transmit a signal to neither the IrDA driver 42 nor the remote control driver 43, and the LED 22 is not driven. i) In the case in which the PWDOWN terminal 25 has H and the TXD terminal 27 has H, the switch 41 is brought into such a state as to transmit a signal to the remote control driver 43 and the LED 22 is driven in the remote control signal transmitting mode.

In the “f” to “i”,. in the case in which the PWDOWN terminal 25 has L, the power down controller 44 for causing the received signal processing portion 40 to be non-conductive is not driven but the received signal processing portion 40 is brought into a conductive state so that the receiving circuit is turned ON. In the case in which the PWDOWN terminal 25 has H, the power down controller 44 for causing the received signal processing portion 40 to be non-conductive is driven and the received signal processing portion 40 is brought into the non-conductive state so that the receiving circuit is turned OFF.

While the signal is input from the controller 50 serving as an IrDA/remote controller to the TXD terminal 27 to be the data signal input terminal in the embodiment, it is also possible to carry out such a design as to produce the same advantages even if the signal is input from the controller 50 serving as an IrDA/remote controller to the TX-RC terminal 24 to be the remote control signal input terminal in place of the TXD terminal 27. It is also possible to create a state in which the LED 22 is always driven in the remote control signal mode by using the TX-RC terminal 24 in place of the TXD terminal 27.

The invention is not restricted to the embodiment but all designs and changes are included in the invention without departing from the scope of the matters described in the claims. For example, the numbers of the controllers and the input terminals are not restricted to those described above. Moreover, the relationship between the operations of the input terminal and the IrDA module is only illustrative. Furthermore, examples of the mobile terminal mounting the IrDA module according to an example of the light receiving and emitting electronic apparatus include a mobile phone, a notebook computer, a personal organizer, and a hand-held PC, and all of terminals which can be carried by people in an ordinary life. In addition to the mobile terminal, referring to the IrDA module according to an example of the light receiving and emitting electronic apparatus in accordance with the invention, it is also possible to mount an electronic apparatus in a daily life other than the mobile terminals, for example, electric household appliances or any apparatus which is operated electrically.

1. A light receiving and emitting electronic apparatus comprising:
a light emitting device;
a light receiving device, and
a driving device for driving the light emitting device and the light receiving device, and serving to transmit/receive data to/from an outside through the light emitting device, wherein
said light receiving device is further comprising:
a data signal input terminal for inputting a data signal from a data signal control device for controlling the driving device in order to transmit/receive data to/from outside;
a remote control signal input terminal for inputting a remote control signal from a remote control signal control device for controlling the driving device in order to remotely operate an external electronic apparatus,
first current generating means for driving a suitable current for transmitting and receiving data into the light emitting device;
second current generating means for driving a suitable current for transmitting the remote control signal into the light emitting device, and
means for selectively switching the first current generating means and second current generating means.

2. The light receiving and emitting electronic apparatus according to claim 1, wherein both a data signal sent from the data signal control device and a remote control signal sent from the remote control signal control device are provided to any one of the data signal input terminal and the remote control signal input terminal.

3. A driving device comprising:
first current generating means for driving a suitable current for transmitting data into a light emitting device;
second current generating means for driving a suitable current for transmitting a remote control signal into the light emitting device;
means for selectively switching the first and second current generating means;
a terminal for transmitting a signal to the light emitting device, and
a terminal for receiving a signal from a light receiving device.

4. The driving device according to claim 3, wherein said driving device is used for a light receiving and emitting electronic apparatus with said light emitting device connected to the terminal for transmitting the signal to the light emitting device, and the light receiving device which is connected to the terminal for receiving a signal from the light receiving device.

5. The light receiving and emitting electronic apparatus comprising;
a light emitting device for emitting a light signal;
a light receiving device for receiving a light signal, and
a driving device which includes at least first current generating means for driving a suitable current for transmitting data into the light emitting device; second current generating means for driving a suitable current for transmitting a remote control signal into the light emitting device, and two input terminals, wherein
if a data signal control device for controlling the driving device so as to transmit/receive data to/from an outside, and a remote control signal control device for controlling the driving device so as to remotely operate an external electronic apparatus are both provided simultaneously, a data signal is then input from the data signal control device to one of said two input terminals, and a remote control signal is input from the remote control signal control device to another input terminal, and
if only a data-remote controller for controlling the driving device is adopted so as to transmit/receive data to/from the outside and control the driving device for remotely operating the external electronic apparatus,
either of the two input terminals can be available for said control by the data-remote controller in any which case of the signal thereof being input from the data-remote controller.

6. The light receiving and emitting electronic apparatus comprising;
a light emitting device for emitting a light signal;
a light receiving device for receiving a light signal, and
a driving device which includes at least first current generating means for driving a suitable current for transmitting data into the light emitting device; second current generating means for driving a suitable current for transmitting a remote control signal into the light emitting device, a first input terminal, and a second input terminal, wherein
if a data signal control device for controlling the driving device so as to transmit/receive data to/from an outside, and a remote control signal control device for controlling the driving device so as to remotely operate an external electronic apparatus are both provided simultaneously, a data signal is then input from the data signal control device to a first input terminals, and a remote control signal is input from the remote control signal control device to said second input terminal, and
if only a data-remote controller for controlling the driving device is adopted so as to transmit/receive data to/from the outside and control the driving device for remotely operating the external electronic apparatus, said second input terminal can be then available for receiving an input signal from said data-remote controller.

7. The light receiving and emitting electronic apparatus comprising;
a light emitting device for emitting a light signal;
a light receiving device for receiving a light signal, and
a driving device which includes at least first current generating means for driving a suitable current for transmitting data into the light emitting device; second current generating means for driving a suitable current for transmitting a remote control signal into the light emitting device, a first input terminal, and a second input terminal, wherein
if a data signal control device for controlling the driving device so as to transmit/receive data to/from an outside, and a remote control signal control device for controlling the driving device so as to remotely operate an external electronic apparatus are both provided simultaneously, a data signal is then input from the data signal control device to a first input terminals, and a remote control signal is input from the remote control signal control device to said second input terminal, and
if only a data-remote controller for controlling the driving device is adopted so as to transmit/receive data to/from the outside and control the driving device for remotely operating the external electronic apparatus, said first input terminal can be then available for receiving an input signal from said data-remote controller.

8. The light receiving and emitting electronic apparatus according to any of claims 1, 2, 6 and 7, wherein the light emitting device is an LED and the light receiving device is a photodiode.

9. The light receiving and emitting electronic apparatus according to any of claims 1-4, 6 and 7, wherein the data signal control device is an IrDA controller.

10. The light receiving and emitting electronic apparatus according to any of claims 1, 2, 6 and 7, wherein said driver device is used for a mobile terminal having the light receiving and emitting devices.

11. The driving device according to claim 3, wherein said driving device is used for a mobile terminal having the light receiving and emitting devices.
